(19) United States
(12) Patent Application Publication
(10) Pub. No.: US 2010/0111486 A1
(43) Pub. Date: May 6, 2010

(54) DISPERSION COMPENSATING MODULE

(75) Inventors: Tetsuya HAYASHI, Yokohama-shi (JP); Eisuke SASAOKA, Yokohama-shi (JP); Kazuya KUWAHARA, Yokohama-shi (JP); Takashi SASAKI, Yokohama-shi (JP); Yasushi KOYANO, Yokohama-shi (JP); Fumiyoshi OHKUBO, Yokohama-shi (JP); Shinjiro HAGIHARA, Yokohama-shi (JP)

Correspondence Address: VENABLE LLP, P.O. BOX 34385, WASHINGTON, DC, 20043-9998, US

(73) Assignee: Sumitomo Electric Industries, Ltd., Osaka-shi (JP)

(21) Appl. No.: 12/611,461

(22) Filed: Nov. 3, 2009

(30) Foreign Application Priority Data
Nov. 5, 2008 (JP) 2008-284516

(51) Int. Cl. G02B 6/00

(52) U.S. Cl. 385/137

(57) ABSTRACT

The present invention relates to a dispersion compensating module having a configuration that can effectively suppress high-speed fluctuations in the polarization state of light even when being imparted with impact or vibration. In the dispersion compensating module, a dispersion compensating optical fiber is fixed while being wound around the barrel of a bobbin, and the bobbin is fixed in the inside of a housing via a buffer that absorbs impact or vibration. The bobbin corresponds to a holder holding the dispersion compensating optical fiber fixed in a state of coil. The housing corresponds to a struct fixing the holder. The buffer fills a space between the housing and the bobbin on which the dispersion compensating optical fiber is coiled.

### BACKGROUND OF THE INVENTION

1. Field of the Invention

The present invention relates to a dispersion compensating module used to compensate for waveform deterioration of signal light in an optical communications system.

2. Related Background of the Invention

In an optical communications system, single-mode optical fibers, which are commonly used as the optical transmission line for transmitting signal light, have positive chromatic dispersion in the signal light wavelength. During signal light propagates through such an optical fiber, its waveform deteriorates due to cumulative chromatic dispersion. In view of this, a dispersion compensating optical fiber or a dispersion compensating module is used as a constituent element of an optical communications system in order to compensate for the waveform deterioration of signal light caused by cumulative chromatic dispersion.

Dispersion compensating optical fibers have a negative chromatic dispersion in the signal light wavelength. When single-mode optical fibers having positive chromatic dispersion and dispersion compensating optical fibers having negative chromatic dispersion are connected at a suitable length ratio, such a configuration lowers the absolute value of the cumulative chromatic dispersion of the overall optical transmission line. This suppresses the waveform deterioration of signal light and makes even faster optical communications possible.

Also, dispersion compensating optical fibers are sometimes installed as part of an optical transmission line of a relay section, but they sometimes also form part of a dispersion compensating module by being held in a housing in a state of being wound in a coil. A dispersion compensating module is an optical component that is disposed in the relays of optical communications systems and so forth, and among its advantages is ease of maintenance.

Meanwhile, in Document 1 (P. M. Krummrich et al., “Extremely fast (microsecond time scale) polarization changes in high speed long haul WDM transmission systems,” OFC 2004, FI3) and in Document 2 (E. Yamada et al., “Fast polarization change due to mechanical vibration of a spooled optical fiber,” 2007 General Conference of the Electronic Information Communications Society, B-10-49, p. 388), there are reports on the effect when a dispersion compensating module, which is constituted by housing such a dispersion compensating optical fiber into a housing while the dispersion compensating optical fiber wound in a state of coil, is imparted with impact or vibration. In particular, according to Documents 1 and 2, the polarization state of output light that has propagated through a dispersion compensating optical fiber changes at high speed. Also, the rate of change of the polarization state of signal light when a dispersion compensating module is imparted with impact or vibration is known to be dependent on the fiber length (see Document 2).

### SUMMARY OF THE INVENTION

The present inventors have examined the above conventional dispersion compensating modules, and as a result, have discovered the following problems. Namely, polarization mode dispersion compensation is sometimes performed in high-speed optical communications. More specifically, the polarization mode dispersion compensation controls, while monitoring the polarization state of signal light, the polarization state so as to keep it constant. In the case that a polarization state of signal light changes at high speed while this polarization mode dispersion compensation is carried out, the polarization mode dispersion compensation is not performed properly because a polarization mode dispersion compensator cannot follow such high speed fluctuations in the polarization state.

Fluctuations in the polarization state of signal light, propagating through an optical transmission line, occurs due to various causes, such as changes in temperature and changes in external force. Of these, high-speed polarization changes in signal light occur when the optical transmission line is imparted with mechanical impact or vibration. Therefore, in the case that a dispersion compensating module, in which a long dispersion compensating optical fiber is housed, is imparted with impact or vibration, high-speed polarization changes will occur, and therefore these will make polarization mode dispersion compensation difficult.

The present invention has been developed to eliminate the problems described above. It is an object of the present invention to provide a dispersion compensating module having a configuration for effectively suppressing high-speed fluctuations in the polarization state of light even when being imparted with impact or vibration.

A dispersion compensating module according to the present invention comprises a dispersion compensating optical fiber, a holder, a buffer, and a struct. Here, the holder holds the dispersion compensating optical fiber with the dispersion compensating optical fiber fixed in a state of coil. The buffer functions to absorb impact or vibration imparted to the holder. The struct fixes the holder via the buffer.

More specifically, the holder has a configuration capable of holding a coiled dispersion compensating optical fiber in a fixed state, and includes, for example, a housing serving as a container for housing this coil in its interior, or a bobbin on which the dispersion compensating optical fiber is wound. The struct is a member that fixes the holder, and includes, for example, an installation bench such as a rack to which the holder is fixed, or a container for housing the holder in its interior. As the buffer, a liquid, a gel, a sponge, rubber, plastic, a spring, an air cushion, an air suspension, or the like can be used favorably.

A first configuration that can be applied to the dispersion compensating module according to the present invention can be realized by a bobbin, on which a dispersion compensating optical fiber has been wound in a state of coil, functioning as the holder and a housing, which housing the holder together with the buffer in its interior, functioning as the struct. In this first configuration, the buffer is arranged so as to be in contact with both the holder and the struct.

Particularly, in the first configuration, when the holder is imparted with impact or vibration via the buffer, there is the possibility that there will be a relative positional change between the housing corresponding to the struct of the dispersion compensating module and the bobbin corresponding to the holder. Meanwhile, in the first configuration, since jumpers corresponding to the end portions of the dispersion compensating optical fiber wound around the bobbin are taken out, there is a greater probability that disconnection will occur in the jumpers, in the condition that these jumpers are fixed to the housing. In view of this, it is preferable that the dispersion compensating module further comprises a configuration for reducing a tension applied to jumpers that constitute part of the dispersion compensating optical fiber and are taken out from the bobbin to the outside of the housing. Also, it is preferable that a take-out part of the jumpers from the housing is provided to the surface perpendicular to the surface where the housing is installed, out of the surfaces constituting the housing, since this prevents the jumpers from being subjected to unnecessary tension.

Furthermore, a second configuration that can be applied to the dispersion compensating module according to the present invention can be realized by a housing, in which a coiled dispersion compensating optical fiber is housed, functioning as the holder and an installation bench, on which the holder is fixed via the buffer, functioning as the struct. In this second configuration, the buffer is arranged so as to be in contact with both the holder and the struct.

### BRIEF DESCRIPTION OF THE DRAWINGS

FIG. 1 is a diagram of a first embodiment (first configuration) of the dispersion compensating module according to the present invention;

FIGS. 2A to 2C are diagrams of modified examples of the jumper take-out configuration in the dispersion compensating module according to the first embodiment;

FIG. 3 is a diagram of a second embodiment (first configuration) of the dispersion compensating module according to the present invention;

FIG. 4 is a diagram of a third embodiment (first configuration) of the dispersion compensating module according to the present invention;

FIG. 5 is a diagram of a fourth embodiment (first configuration) of the dispersion compensating module according to the present invention;

FIG. 6 is a diagram of a fifth embodiment (first configuration) of the dispersion compensating module according to the present invention;

FIGS. 7A and 7B are diagrams of a sixth embodiment (second configuration) of the dispersion compensating module according to the present invention;

FIG. 8 is a diagram of a seventh embodiment (second configuration) of the dispersion compensating module according to the present invention;

FIG. 9 is a diagram of the cross sectional struct of the dispersion compensating module according to the seventh embodiment shown in FIG. 8;

FIG. 10 is a diagram of an eighth embodiment (second configuration) of the dispersion compensating module according to the present invention; and

FIG. 11 is a diagram of a ninth embodiment (second configuration) of the dispersion compensating module according to the present invention.

### DESCRIPTION OF THE PREFERRED EMBODIMENTS

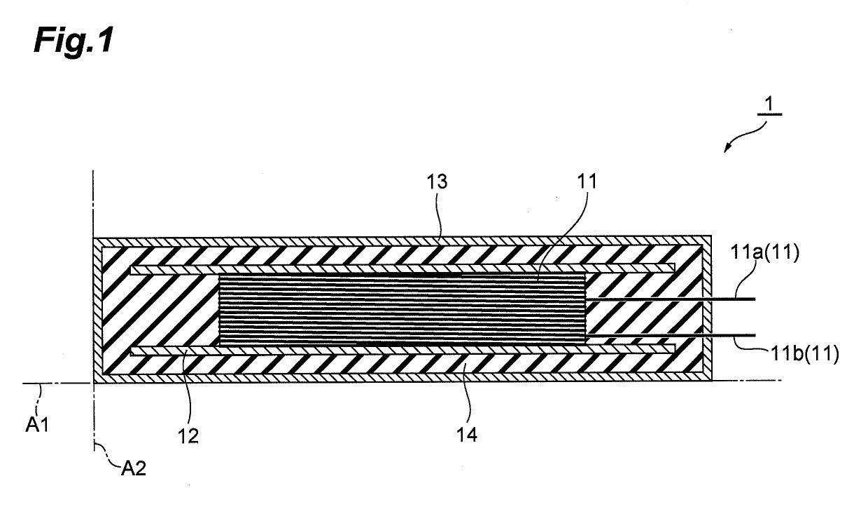

In the following, embodiments of the dispersion compensating module according to the present invention will now be described in detail through reference to FIGS. 1, 2A to 2C, 3 to 6, 7A and 7B, and 8 to 11. In the description of the drawings, identical or corresponding components are designated by the same reference numerals, and overlapping description is omitted.

The dispersion compensating module according to the present embodiment comprises a dispersion compensating optical fiber, a holder holding the dispersion compensating optical fiber fixed in a state of coil, a buffer absorbing impact or vibration imparted to the holder, and a struct fixing the holder via the buffer. Incidentally, in the dispersion compensating module, various configurations can be realized by the combination of a constituent element serving as the holder and a constituent element serving as the struct. Therefore, in the following description, the first to fifth embodiments will be explained as an embodiment having a first configuration, and sixth to ninth embodiments will be explained as an embodiment having a second configuration.

FIG. 1 is a diagram of a first embodiment of the dispersion compensating module according to the present invention. The dispersion compensating module 1 according to the first embodiment comprises a dispersion compensating optical fiber 11, a bobbin 12 around the barrel of which the dispersion compensating optical fiber 11 is fixed in a state of being wound, a housing 13 in which the entire bobbin 12 is housed, and a buffer 14 filled in the space between the bobbin 12 and the inner walls of the housing 13. The buffer 14 is a material or configuration that absorbs impact or vibration applied to the bobbin 12, and functions to fix the bobbin 12 in a specific location in the interior of the housing 13.

In the dispersion compensating module 1 according to this first embodiment, the first configuration is realized by the bobbin 12 functioning as a holder that holds the dispersion compensating optical fiber 11 fixed in a state of coil and the housing 13 functioning as a struct fixing the holder. The first configuration is also employed for the dispersion compensating modules 2 to 5 according to the second to fifth embodiments, which are described below.

In the dispersion compensating module 1 according to the first embodiment having the first configuration as discussed above, the buffer 14 is filled in the space between the housing 13 and the bobbin 12 whose barrel is wound with the dispersion compensating optical fiber 11. Furthermore, in this first embodiment, the buffer 14 is also filled in the space between the two flanges of the bobbin 12 (which together function to sandwich the dispersion compensating optical fiber 11 wound around the barrel). In the dispersion compensating module 1 constituted in this way, even when the housing 13 is imparted with impact or vibration, the action of the buffer 14 will effectively reduce impact or vibration applied to the dispersion compensating optical fiber 11 wound around the barrel of the bobbin 12. Accordingly, high-speed fluctuations in the polarization state of light propagating through the dispersion compensating optical fiber 11 can be suppressed.

In the dispersion compensating module 1 according to this first embodiment, the dispersion compensating optical fiber 11 that is wound around the barrel of the bobbin 12 has an end 11a including one light input/output end surface, and an end 11b including the other light input/output end surface, with these being called jumpers and constituting part of the dispersion compensating optical fiber 11 that is taken out from the bobbin 12 to the outside of the housing 13. Also, as shown in FIG. 1, the dispersion compensating module 1 may be disposed on an installation surface A1, or on an installation surface A2.

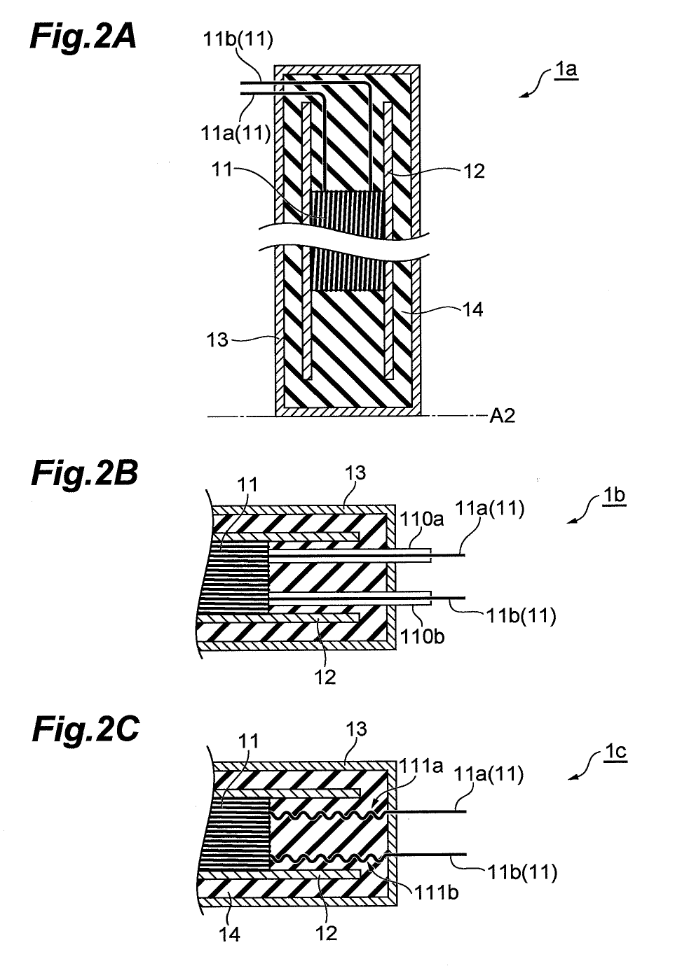

In the first configuration described above, when the bobbin 12 is imparted with impact or vibration via the housing 13, there is the possibility of a relative positional change occurring between the housing 13 corresponding to the struct and the bobbin 12 corresponding to the holder. On the other hand, in the first configuration, since the jumpers 11a and 11b corresponding to the end portions of the dispersion compensating optical fiber 11 wound around the barrel of the bobbin 12 are taken out to the outside of the housing 13, there is a greater probability of disconnection in the jumpers 11a and 11b in the condition that the jumpers 11a and 11b are fixed to the housing 13. In view of this, various modified examples can be applied in an effort to reduce the risk of disconnection in the jumpers 11a and 11b (part of the dispersion compensating optical fiber 11). FIGS. 2A to 2C are diagrams of various modified examples of the jumper take-out struct in the dispersion compensating module 1 according to the first embodiment. The various configurations described below (FIGS. 2A to 2C) are not limited to the dispersion compensating module 1 according to the first embodiment, and can also be applied to the embodiments discussed below, namely, the dispersion compensating modules 2 to 5 according to the second to fifth embodiments to which the first configuration is applied, as well as to the dispersion compensating modules 6 to 9 according to the sixth to ninth embodiments to which the second configuration is applied.

Specifically, in the dispersion compensating module 1 according to the first embodiment, the part of the jumper 11a and the part of the jumper 11b located inside the housing 13 are fixed by the buffer 14, while the part of the jumper 11a and the part of the jumper 11b located outside the housing 13 are not fixed. In this case, there is the risk of disconnection in the jumpers 11a and 11b at the open ends of the through-holes in the housing 13 through which the jumpers 11a and 11b pass. Therefore, the jumpers 11a and 11b are preferably taken out from a surface, out of the surfaces constituting the housing 13, perpendicular to the installation surface of the dispersion compensating module 1. For example, in the case that the dispersion compensating module 1 is placed on the installation surface A1, as shown in FIG. 1, the jumpers 11a and 11b are preferably taken out from a surface of the housing 13 that is perpendicular to the installation surface A1. On the other hand, the dispersion compensating module 1a shown in FIG. 2A is installed on the installation surface A2, and the jumpers 11a and 11b are taken out from a surface of the housing 13 that is perpendicular to the installation surface A2.

Also, in the dispersion compensating module 1b shown in FIG. 2B, hollow pipes 110a and 110b are fixed in a state of passing through the housing 13 so that the jumpers 11a and 11b do not come into direct contact with the housing 13. In this case, since the jumpers 11a and 11b are taken out to the outside of the housing 13 in a state of passing through the hollow pipes 110a and 110b, the positions of the hollow pipes 110a and 110b with respect to the housing 13 can be varied freely. Therefore, even when the relative position of the bobbin 12 with respect to the housing 13 should change due to impact or vibration, the jumpers 11a and 11b can be prevented from being subjected to unnecessary tension.

In the dispersion compensating module 1c shown in FIG. 2C, surplus length portions 111a and 111b are provided to the portions of the jumpers 11a and 11b located inside the housing 13. In this case, the surplus length portions 111a and 111b of the jumpers 11a and 11b will absorb any change in the relative position of the bobbin 12 with respect to the housing 13 caused by impact or vibration, so the jumpers 11a and 11b can be prevented from being subjected to unnecessary tension. Furthermore, the surplus length portions 111a and 111b of the jumpers 11a and 11b may be housed in the housing 13 while being brought together in a state of loop shape or infinity sign shape, or being brought together in a spiral manner like a spring.

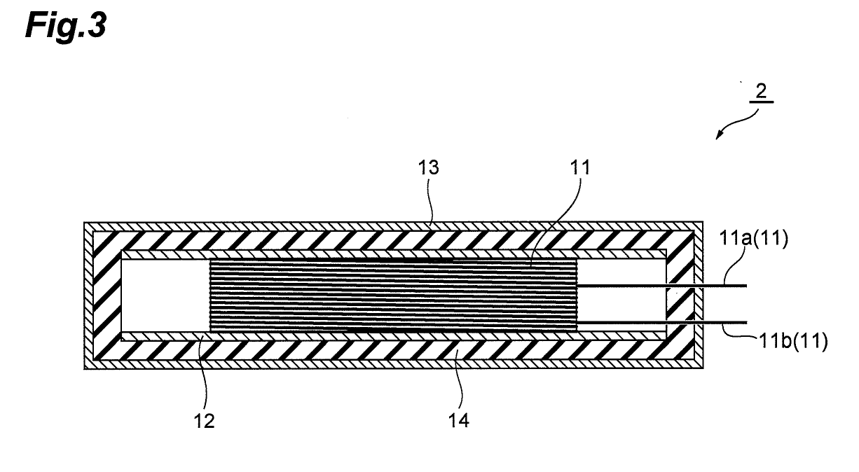

FIG. 3 is a diagram of a second embodiment of the dispersion compensating module according to the present invention, and the dispersion compensating module 2 in the second embodiment also has the first configuration, just as in the first embodiment. The configurations shown in FIGS. 2A to 2C can also be applied to this dispersion compensating module 2 according to the second embodiment.

Specifically, in the dispersion compensating module 2 according to the second embodiment, the configuration, which is constituted by the bobbin 12 functioning as the holder and the housing 13 functioning as the struct, is the same as in the first embodiment described above. In the dispersion compensating module 2 according to the second embodiment, the buffer 14 is filled in the space between the bobbin 12 and the housing 13, but is not filled in the space between the two flanges of the bobbin 12. Again in the dispersion compensating module 2 constituted in this way, when the housing 13 is imparted with impact or vibration, the action of the buffer 14 reduces the impact or vibration that is applied to the dispersion compensating optical fiber 11 wound around the barrel of the bobbin 12. Therefore, again in the dispersion compensating module 2 according to the second embodiment, high-speed changes in the polarization state of light propagating through the dispersion compensating optical fiber 11 can be effectively suppressed.

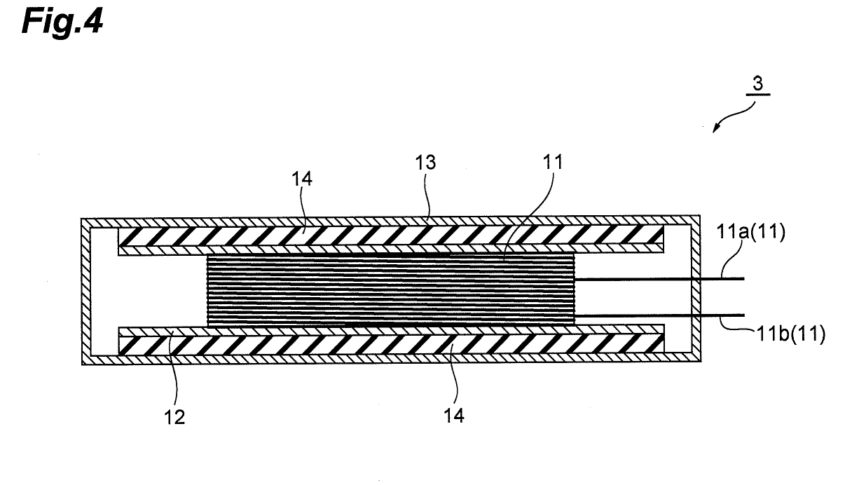

FIG. 4 is a diagram of a third embodiment of the dispersion compensating module according to the present invention, and the dispersion compensating module 3 according to the third embodiment also has the first configuration, just as in the first embodiment. The configurations shown in FIGS. 2A to 2C can also be applied to this dispersion compensating module 3 according to the third embodiment.

Specifically, in the dispersion compensating module 3 according to the third embodiment, the configuration, which is constituted by the bobbin 12 functioning as the holder and the housing 13 functioning as the struct, is the same as in the first embodiment described above. In the dispersion compensating module 3 in the third embodiment, the buffer 14 is filled in the space between the flanges of the bobbin 12 and the opposing wall surfaces of the housing 13, but is not filled in the space between the two flanges of the bobbin 12, nor is it filled in the space between the bobbin 12 and the side surfaces of the housing 13. Again in the dispersion compensating module 3 constituted in this way, when the housing 13 is subjected to impact or vibration, the action of the buffer 14 reduces the impact or vibration that is applied to the dispersion compensating optical fiber 11 wound around the barrel of the bobbin 12. As a result, again in the dispersion compensating module 3 according to the third embodiment, high-speed changes in the polarization state of light propagating through the dispersion compensating optical fiber 11 can be effectively suppressed.

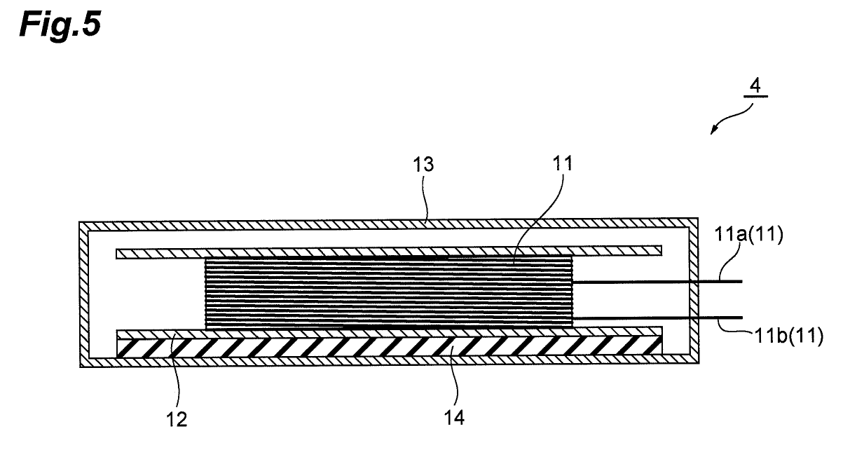

FIG. 5 is a diagram of a fourth embodiment of the dispersion compensating module according to the present invention, and the dispersion compensating module 4 according to the fourth embodiment also has the first configuration, just as in the first embodiment. The configurations shown in FIGS. 2A to 2C can also be applied to this dispersion compensating module 4 according to the fourth embodiment.

Specifically, in the dispersion compensating module 4 according to the fourth embodiment, the configuration, which is constituted by the bobbin 12 functioning as the holder and the housing 13 functioning as the struct, is the same as in the first embodiment described above. In the dispersion compensating module 4 in the fourth embodiment, the buffer 14 is filled in only the space between one flange of the bobbin 12 and the opposing wall surface of the housing 13. On the other hand, the buffer 14 is not filled in the space between the two flanges of the bobbin 12, nor is it filled in the space between the other flange of the bobbin 12 and the opposing side surface of the housing 13, nor is it filled in the space between the bobbin 12 and the side surfaces of the housing 13. Again in the dispersion compensating module 4 constituted in this way, when the housing 13 is subjected to impact or vibration, the action of the buffer 14 reduces the impact or vibration that is applied to the dispersion compensating optical fiber 11 wound around the barrel of the bobbin 12. As a result, again in the dispersion compensating module 4 according to the fourth embodiment, high-speed changes in the polarization state of light propagating through the dispersion compensating optical fiber 11 can be effectively suppressed.

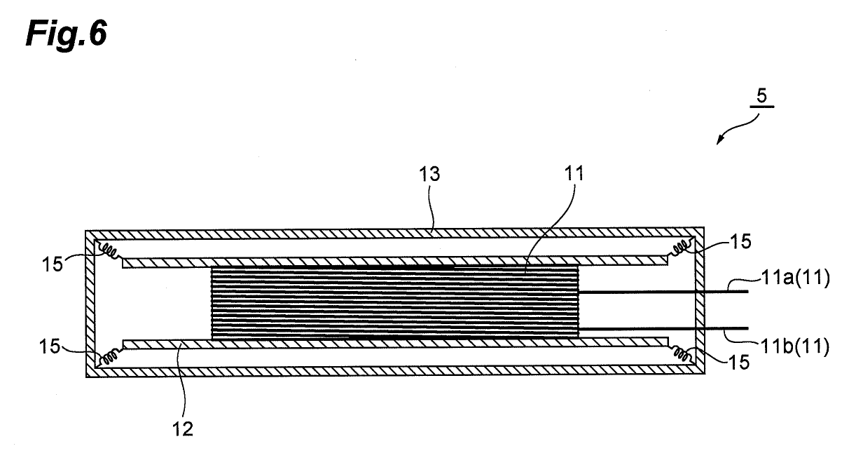

FIG. 6 is a diagram of a fifth embodiment of the dispersion compensating module according to the present invention, and the dispersion compensating module 5 according to the fifth embodiment also has the first configuration, just as in the first embodiment. The configurations shown in FIGS. 2A to 2C can also be applied to this dispersion compensating module 5 according to the fifth embodiment.

Specifically, in the dispersion compensating module 5 according to the fifth embodiment, the configuration, which is constituted by the bobbin 12 functioning as the holder and the housing 13 functioning as the struct, is the same as in the first embodiment described above. In the dispersion compensating module 5 in the fifth embodiment, a buffer 15 is a member that connects the flanges of the bobbin 12 to the wall surfaces of the housing 13, and is constituted by a cord-like member, a spring, or the like that is elastic. The bobbin 12 serving as the holder floats in the internal space of the housing 13 without touching the inner wall surfaces of the housing 13. In the dispersion compensating module 5 constituted in this way, when the housing 13 is subjected to impact or vibration, the action of the buffer 15 reduces the impact or vibration that is applied to the dispersion compensating optical fiber 11 wound around the barrel of the bobbin 12. As a result, again in the dispersion compensating module 5 according to the fifth embodiment, high-speed changes in the polarization state of light propagating through the dispersion compensating optical fiber 11 can be effectively suppressed.

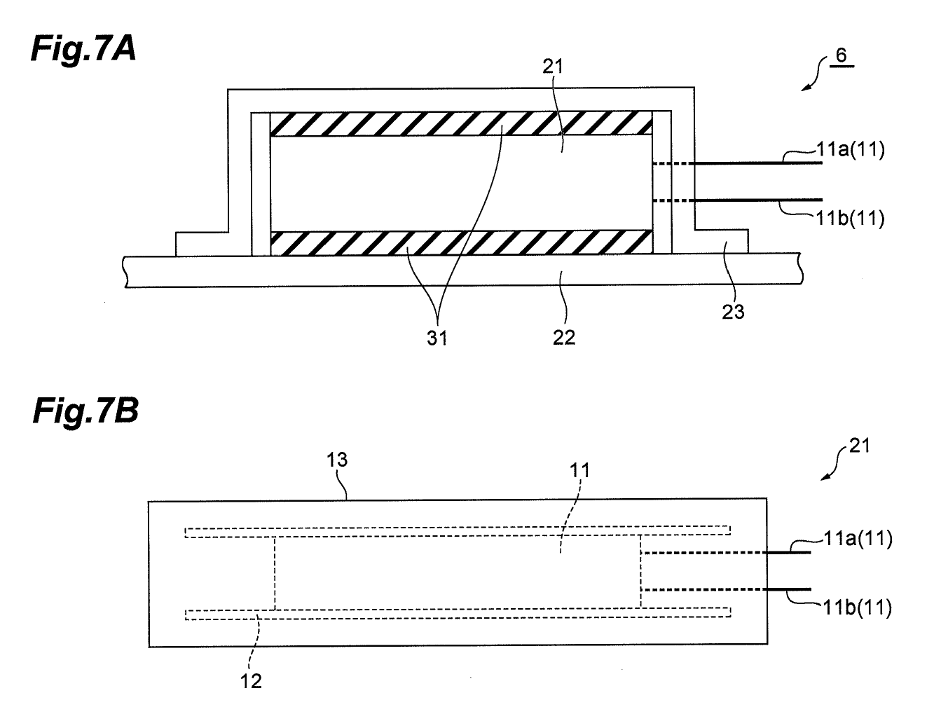

FIGS. 7A and 7B are diagrams of a sixth embodiment of the dispersion compensating module according to the present invention, and the dispersion compensating module 6 according to the sixth embodiment has a second configuration, unlike in the first to fifth embodiments.

In particular, as shown in FIG. 7A, the dispersion compensating module 6 according to the sixth embodiment comprises a holder 21 housing an dispersion compensating optical fiber wound in a state of coil, a rack 22, a fastener 23, an a buffer 31. An installation bench to which the holder 21 is fixed is constituted by the rack 22 and the fastener 23. The internal struct of the holder 21 is as shown in FIG. 7B, for example, in which a bobbin 12, around the barrel of which is coiled the dispersion compensating optical fiber 11, is fixed inside the housing 13. The internal structure of the buffer 31 shown in FIG. 7B differs from the above-mentioned first embodiment in that the housing 13 serving as the container and the bobbin 12 located in the interior thereof are fixed by a suitable member (no buffer is present inside the housing 13).

In the dispersion compensating module 6 according to the sixth embodiment, the holder 21 is placed on the rack 22, and is fixed to the rack 22 by the fastener 23 via the buffer 31, which absorbs impact or vibration, in a state of being entirely covered. The jumpers 11a and 11b, which constitute part of the dispersion compensating optical fiber housed inside the holder 21, are taken out to the outside of the module via the rack 22 and the fastener 23, and the configurations shown in FIGS. 2A to 2C can also be applied as needed to the dispersion compensating module 6 according to the sixth embodiment.

In the second configuration applied to the dispersion compensating module 6 according to the sixth embodiment, the holder 21 houses the dispersion compensating optical fiber fixed in a state of coil. The rack 22 and the fastener 23 constituting the installation bench correspond to a struct for fixing the holder. In the dispersion compensating module 6 in the sixth embodiment, the buffer 31 is filled in the space between the rack 22 and the holder 21 holding the dispersion compensating optical fiber, and also is filled in the space between the holder 21 and the fastener 23. In the dispersion compensating module 6 constituted in this way, when the rack 22 is subjected to impact or vibration, the action of the buffer 31 will reduce the impact or vibration that is applied to the dispersion compensating optical fiber housed in the holder 21. As a result, high-speed changes in the polarization state of light propagating through the dispersion compensating optical fiber 11 can be effectively suppressed.

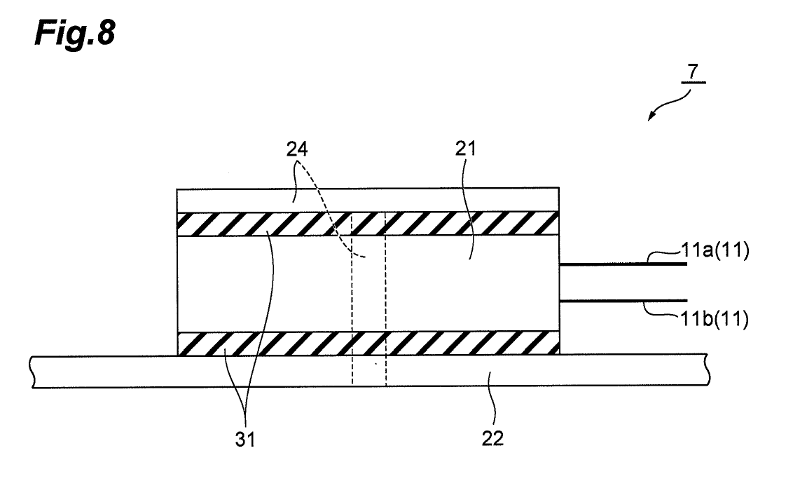

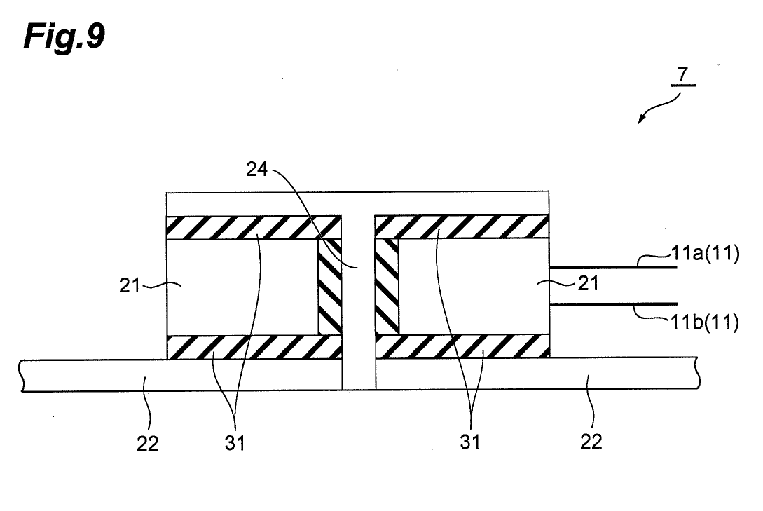

FIG. 8 is a diagram of a seventh embodiment of the dispersion compensating module according to the present invention, and FIG. 9 is a diagram illustrating the cross sectional configuration of the dispersion compensating module according to the seventh embodiment shown in FIG. 8. The dispersion compensating module 7 according to the seventh embodiment also has the second configuration, just as in the sixth embodiment.

Specifically, in the dispersion compensating module 7 according to the seventh embodiment, the holder 21 that houses the coiled dispersion compensating optical fiber is placed on the rack 22, and is fixed by a fastener 24 via the buffer 31 that absorbs impact or vibration. The holder 21 has a through-hole in its center, and the fastener 24 is fixed with the rack 22 through this through-hole. The second configuration is applied to the dispersion compensating module 7 according to the seventh embodiment, and therefore the holder 21 houses the dispersion compensating optical fiber fixed in a state of coil. The fastener 24 and the rack 22 constituting the installation bench correspond to a struct for fixing the holder. The jumpers 11a and 11b constituting part of the dispersion compensating optical fiber housed in the holder 21 are taken out to the outside of the module via the housing 13 (see FIG. 7B), and again in the dispersion compensating module 7 according to the seventh embodiment, the configurations shown in FIGS. 2A to 2C can be applied as needed.

In the dispersion compensating module 7 according to the seventh embodiment, the buffer 31 is filled in the space between the rack 22 and the holder 21 housing the dispersion compensating optical fiber, and us filled in the space between the fastener 24 and the holder 21. In the dispersion compensating module 7 constituted in this way, even when the rack 22 is subjected to impact or vibration, the action of the buffer 31 will reduce the impact or vibration that is applied to the dispersion compensating optical fiber held in the holder 21. As a result, high-speed changes in the polarization state of light propagating through the dispersion compensating optical fiber 11 can be effectively suppressed.

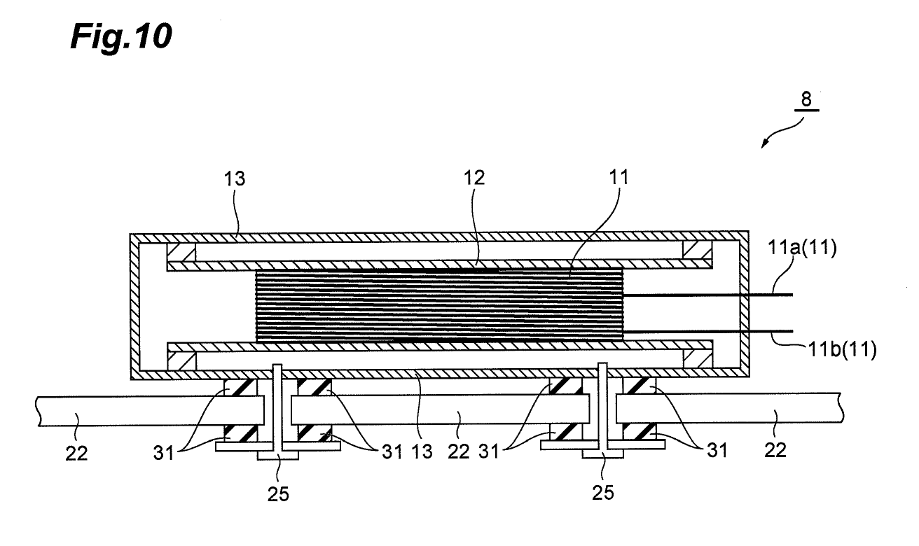

FIG. 10 is a diagram of an eighth embodiment of the dispersion compensating module according to the present invention, and the dispersion compensating module 8 according to the eighth embodiment has the second configuration, just as in the sixth embodiment.

Specifically, in the dispersion compensating module 8 according to the eighth embodiment, the dispersion compensating optical fiber 11 is fixed in a state of being wound around the barrel of the bobbin 12. Also, the bobbin 12, on the barrel of which is wound the dispersion compensating optical fiber 11, is housed inside the housing 13. The bobbin 12 is fixed to the housing 13 by a specific member so that the relative positions of the bobbin 12 and the housing 13 will not change. Also, the housing 13 having such a configuration has substantially the same configuration as in the sixth and seventh embodiments described above (see FIG. 7B). The housing 13 is placed on the rack 22, and is fixed by a fastener 25 via the buffer 31 that absorbs impact or vibration. The fastener 25 is fixed to the bottom surface of the bobbin 12 through the rack 22 from under the rack 22. The second configuration is applied to the dispersion compensating module 8 of this eighth embodiment, and therefore the bobbin 12 and the housing 13 (corresponding to the holder 21 in the sixth and seventh embodiments above) correspond to a holder that houses the dispersion compensating optical fiber 11 fixed in a state of coil. Also, the fastener 25 and the rack 22 constituting the installation bench correspond to a struct that fixes the holder. The jumpers 11a and 11b constituting part of the dispersion compensating optical fiber 11 held in the housing 13 are taken out to the outside of the module via the housing 13, and the configurations shown in FIGS. 2A to 2C can be applied as needed to the dispersion compensating module 8 according to this eighth embodiment as well.

In the dispersion compensating module 8 according to the eighth embodiment, the buffer 31 is filled in the space between the rack 22 and the housing 13 that houses the dispersion compensating optical fiber 11, and is also filled in the space between the fastener 25 and the housing 13. In the dispersion compensating module 8 constituted in this way, even when the rack 22 is subjected to impact or vibration, the action of the buffer 31 will reduce the impact or vibration that is applied to the dispersion compensating optical fiber 11 housed in the housing 13, so high-speed changes in the polarization state of light propagating through the dispersion compensating optical fiber 11 can be suppressed.

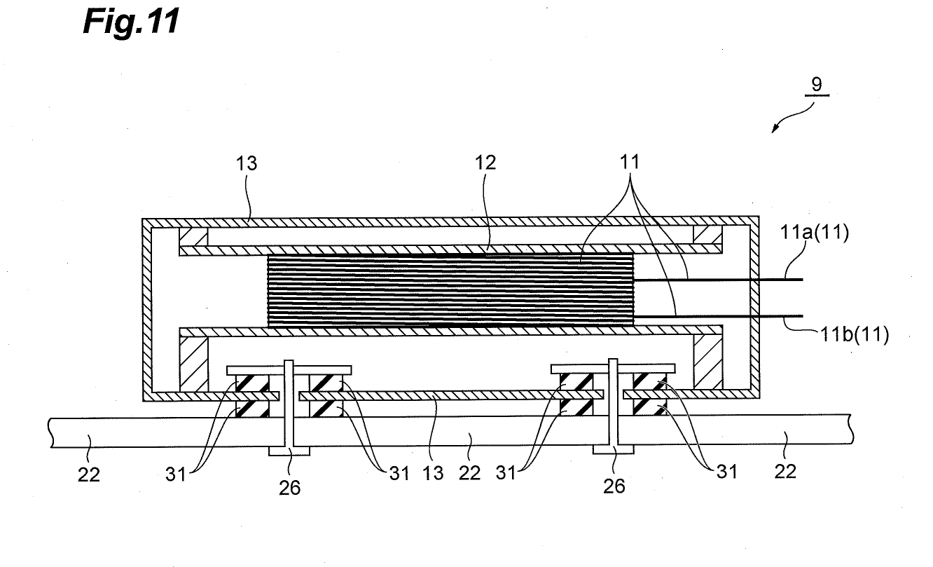

FIG. 11 is a diagram of a ninth embodiment of the dispersion compensating module according to the present invention, and the dispersion compensating module 9 according to the ninth embodiment also has the second configuration.

Specifically, in the dispersion compensating module 9 according to the ninth embodiment, the dispersion compensating optical fiber 11 is fixed in a state of being wound around the barrel of the bobbin 12. Also, the bobbin 12, on the barrel of which is wound the dispersion compensating optical fiber 11, is housed inside the housing 13 (just as in the eighth embodiment above, the bobbin 12 and the housing 13 are fixed via a specific member). The housing 13 is placed on the rack 22, and is fixed by a fastener 26 via the buffer 31 that absorbs impact or vibration. The fastener 26 is fixed to the rack 22 through the bottom surface of the bobbin 12 from inside the bobbin 12. The second configuration is applied to the dispersion compensating module 9 of the ninth embodiment, and therefore the bobbin 12 and the housing 13 correspond to a holder housing the dispersion compensating optical fiber 11 fixed in a state of coil. Also, the fastener 26 and the rack 22 constituting the installation bench correspond to a struct that fixes the holder. The jumpers 11a and 11b constituting part of the dispersion compensating optical fiber 11 housed in the housing 13 are taken out to the outside of the module via the housing 13, and the configurations shown in FIGS. 2A to 2C can be applied as needed to the dispersion compensating module 9 according to the ninth embodiment as well.

In the dispersion compensating module 9 in the ninth embodiment, the buffer 31 is filled in the space between the rack 22 and the housing 13 housing the dispersion compensating optical fiber 11 (wound around the barrel of the bobbin 12), and is also filled in the space between the housing 13 and the fastener 26. In the dispersion compensating module 9 constituted in this way, even when the rack 22 is subjected to impact or vibration, the action of the buffer 31 will effectively reduce impact or vibration applied to the dispersion compensating optical fiber 11 housed in the housing 13. As a result, high-speed fluctuations in the polarization state of light propagating through the dispersion compensating optical fiber 11 can be suppressed.

As described above, in the dispersion compensating module according to the present invention, even when the holding struct for a dispersion compensating optical fiber is subjected to impact or vibration, high-speed fluctuations in the polarization state of light propagating through the dispersion compensating optical fiber can be effectively suppressed.

What is claimed is:

1. A dispersion compensating module, comprising:
a dispersion compensating optical fiber;
a holder holding the dispersion compensating optical fiber fixed in a state of coil;
a buffer absorbing impact or vibration imparted to the holder; and
a struct fixing the holder via the buffer.

2. A dispersion compensating module according to claim 1, wherein the buffer is arranged so as to be in contact with both the holder and the struct.

3. A dispersion compensating module according to claim 1, wherein the holder includes a bobbin on which the dispersion compensating optical fiber is coiled.

4. A dispersion compensating module according to claim 1, wherein the holder includes a housing in which the dispersion compensating optical fiber coiled is housed.

5. A dispersion compensating module according to claim 1, further comprising, between the holder and the struct, a configuration for reducing a tension applied to a jumper which constitutes part of the dispersion compensating optical fiber and is taken out to the outside of the holder.

6. A dispersion compensating module according to claim 1, wherein the struct including a housing in which the holder is housed together with the buffer.

7. A dispersion compensating module according to claim 1, wherein the struct includes an installation bench on which the holder is fixed via the buffer.
